(19) United States
(12) Patent Application Publication
(10) Pub. No.: US 2010/0129479 A1
(43) Pub. Date: May 27, 2010

(54) PELLETIZING DIE PLATE, PELLETIZING DIE ASSEMBLY, AND METHOD FOR MAKING THE SAME

(75) Inventors: Debangshu Banerjee, Springdale, AK (US); Shivanand I. Majagi, Rogers, AK (US); Stephan Badot, Kingwood, TX (US); Harold E. Kelley, Fallon, NV (US)

Correspondence Address: KENNAMETAL INC.;Intellectual Property Department, P.O. BOX 231, 1600 TECHNOLOGY WAY, LATROBE, PA, 15650, US

(73) Assignee: Kennametal Inc., Latrobe, PA (US)

(21) Appl. No.: 12/277,398

(22) Filed: Nov. 25, 2008

(51) Int. Cl. B29B 9/10; B22C 3/00

(52) U.S. Cl. 425/6; 427/135

(57) ABSTRACT

A pelletizing die plate is useful with a main die body with passageways. The pelletizing die plate includes a die plate body, which is made of a hard composite material. The hard composite material contains a low thermal conductivity matrix of hard matrix particles and an infiltrant alloy bonded to the hard matrix particles to form the hard composite material. The hard matrix particles includes between greater than zero and up to about 20 weight percent titanium carbide particles and the balance cast tungsten carbide particles. The infiltrant alloy contains at least one or more of nickel and copper. The hard matrix particles are between about 50 weight percent and about 70 weight percent of the hard composite material and the infiltrant alloy are between about 30 weight percent and about 50 weight percent of the hard composite material. The hard composite material has a thermal conductivity less than or equal to about 25 Watt/m° K. The die plate body has bores in alignment with the passageways in the main die body thereby forming continuations of the passageways of the main die body. A method of making a pelletizing die assembly that has the steps of: providing a main die body wherein the main die body having a first end face and a second end face, and a plurality of passageways extending through said main die body between said first and second end faces; placing a first mass of hard matrix particles on the second end face of the main die body; placing a second mass of infiltrant alloy on the first mass of hard matrix particles; heating the first mass and the second mass whereby the infiltrant alloy infiltrates the first mass to form a hard composite material comprising a solid mass of the hard matrix particles bonded together by the infiltrant alloy; and forming bores in the hard composite material to form a top die plate wherein the bores are in alignment with the passageways in the main die body.

### BACKGROUND OF THE INVENTION

The present invention pertains to an extrusion die (e.g., pelletizing die) and especially a pelletizing die plate, as well as a method for making the same. More particularly, the invention pertains to an improved pelletizing die (and improved pelletizing die plate) of the type used for extrusion of synthetic resins and plastics. The improved pelletizing die plate exhibits advantageous properties (i.e., lower thermal conductivity, higher wear resistance, higher corrosion resistance, and a uniform die plate face) that increase the productivity of the pelletizing die assembly and the quality of the pellets or granules produced thereby.

Pelletizing is a process for producing a uniform particle size of newly produced or recycled plastic resins. The petroleum industry uses this process to produce pelletized polyethylene, polypropylene, and other polymeric materials with filler materials in them to allow more efficient handling and processing of the materials. The pelletizing process begins with a rotary extruder, which extrudes the resin or plastic material in a molten or fluid state through an extrusion die having a multiplicity of small diameter extrusion passages. The resin or plastic material exits the extrusion passages in the form of strands. Typically, the pelletizing process is performed under water such that the plastic material solidifies just as it is leaving the die. As the material exits from the face of the die, the strands are cut by a rotating knife (or set of rotating knives) passing along the surface of the die face immediately upon exiting the die. This operation takes place in a closed environment as water circulates through to both cool the pelletizing die face and to carry the pellets out of the closed environment. The pellets are then transferred to a dewatering/drying system prior to final packing or further processing.

As is apparent from a description of the pelletizing process, the pelletizing die face is subjected to a number of deleterious environmental conditions. For example, there exist temperature extremes from the higher temperature of the molten resin or plastic to the lower temperature of the water. Further, there exist corrosion issues due to the constant submersion of the die plate in a water environment. Still further, there is constant surface abrasion from the flowing polymer material and movement of the cutting knives. These environmental conditions present challenges to the successful operation of the pelletizing plate and the pelletizing die assembly.

While earlier pelletizing apparatus adequately extrude plastic materials, which knives then cut into pellets or granules, there remains a desire to improve the overall productivity of the pelletizing die assembly. There is also the desire to improve the quality of these pellets or granules. As is apparent from the environmental conditions in which the pelletizing die assembly operates, there are challenges to any attempt to increase productivity and quality of the pellets or granules.

One challenge to increase overall productivity of the pelletizing die assembly has been to lessen or eliminate wear on the face of the dies, and especially on the face of the pelletizing die plate. The face of the pelletizing die plate experiences wear due to the contact with the knives. The pelletizing die plate also experiences wear in the vicinity of the passages due to the abrasive nature of the polymer moving through the passages.

In the past, one way to reduce the wear-related issues has been to use discrete hard members in the areas of wear. Heretofore, one common approach has been to position wear pads in the face of the die plate, as well as surround the extrusion passageways with a hard insert. For example, U.S. Pat. No. 3,599,285 to Hamilton discloses a pelletizing die plate that uses carbide facing as a backing support for the nozzles. U.S. Pat. No. 4,516,925 to Fujita et al. discloses a pelletizing die that uses a sintered hard tip pressing plate that surrounds a sintered hard tip. U.S. Pat. No. 6,547,549 B2 to Scheider et al. discloses a pelletizing die that includes wearing-protection inserts that protect against wear from the cut-off knife that wipe across the cutting surface of the die. European Patent No. 1 275 483 B2 to Knight et al. discloses a pelletizing die that uses a hardened surface at the point the polymer exits the extrusion orifices.

In reference to the hard material itself, two common die face materials used as wear pads and orifice nibs are ferro-titanium carbide (Ferro-TiC) and tungsten carbide cobalt (WC—Co) alloys. In some instances, the wear pads and orifice nibs are embedded in a stainless steel alloy and/or a ceramic material of the die face plate. Ferro-TiC is a machineable and hardenable alloy/steel bonded titanium carbide. Ferro-TiC is typically a metal matrix composite of titanium carbide (TiC) plus chromium (Cr), molybdenum (Mo), carbon-iron alloy (C—Fe), and/or titanium. For example, a typical Ferro-TiC composition, as recited in U.S. Pat. No. 5,366,138 (Vela et al.), includes 30-32% TiC, 9-10% Cr, 3-6.5% Co, 3-4.5% Ni, 2-4% Mo, 0-1% Al, 1-2% Ti, 0-1% Cr, and 40-50% Fe. The ultra-hard, rounded titanium carbide grains are uniformly distributed throughout a hardenable steel alloy matrix.

Tungsten carbide-cobalt (WC—Co) based cemented carbides include a range of composite materials which contain hard carbide particles bonded together by a metallic binder. The proportion of carbide phase is generally between 70-97% of the total weight of the composite and its grain size averages between 0.2 and 14 micrometers. For example, a typical cobalt-bound tungsten carbide material is disclosed in U.S. Pat. No. 4,923,512 (Timm et al.) Timm et al. recites a composition having WC in an amount of 83 to 99 weight % and cobalt in an amount of 1-18 weight %. Tungsten carbide (WC), the hard phase, together with cobalt (Co), the binder phase, forms the basic cemented carbide structure. In addition to WC—Co compositions, cemented carbide may contain proportions of secondary carbides such as titanium carbide (TiC), tantalum carbide (TaC), and niobium carbide (NbC). These secondary carbides are mutually soluble and can also dissolve a high proportion of tungsten carbide. In addition, cemented carbides are produced which have the cobalt binder phase alloyed with, or completely replaced by, other metals such as nickel (Ni), chromium (Cr), molybdenum (Mo), iron (Fe), or alloys of these elements.

As one can appreciate, there is an advantage with a pelletizing die that exhibits a high degree of wear resistance. Thus, it would be highly desirable to provide an improved pelletizing die that can exhibit a high degree of wear resistance, and especially a die face that exhibits a high degree of wear resistance.

In the pelletizing dies that employ wear pads, there occurs regions that are harder and regions that are softer. The die plate face does not present a surface that has a uniform hardness. As one can appreciate, a non-uniform die plate face can lead to uneven wear, which can adversely affect the performance of the die assembly. Further, in pelletizing dies that employ wear pads, the wear pads often have to be brazed to the face. This requires an additional step in the manufacturing process, as well as creates a braze joint that can be subject to wear and other detrimental environmental forces.

As one can appreciate, there is an advantage with a pelletizing die that can present a die face that is uniform. In other words, the die face has an absence of harder regions and softer regions. Thus, it would be highly desirable to provide an improved pelletizing die with a uniform die face wherein there is an absence of harder regions and softer regions.

As one can appreciate, there is an advantage with a pelletizing die that does not employ wear pads brazed to the die plate face. In other words, the die face has an absence of braze joints, as well as needs less manufacturing steps. Thus, it would be highly desirable to provide an improved pelletizing die a pelletizing die that does not employ wear pads brazed to the die plate face.

Another challenge to increase overall production has been to lessen or eliminate the solidification of material passing through the die. Premature solidification of the material can result in plugging or “freezing-off” of the extrusion passages and/or outlet orifices. Such an occurrence is very undesirable for any number of reasons including the necessity to cease production to unplug the extrusion passages or outlet orifices resulting in a reduction of productivity to poor quality pellets.

In an effort to maintain the material molten during its passage through the die, the dies have typically been designed with internal heating passages through which steam or heated oil has been circulated. Various arrangements in the die help retard the flow of heat from the body of the die to the cooling bath. One exemplary arrangement comprises using layers of insulation to cover the exposed faces of the die, or the insulation layer can rest between the die face and the main die body. Another exemplary arrangement comprises providing the dies passages with insulating sleeves to retard heat flow from the molten plastic to the die body or face. The fact that the die plate face is continuously cooled with water makes the retention of the necessary heat in the molten material even more difficult.

Another attempt to address the “freezing” problem has been to provides wear pads and orifice nibs from a carbide material that has a coefficient of thermal conductivity lower than heretofore used in pelletizing die assemblies. U.S. Pat. No. 6,521,353 to Majagi et al. for a LOW THERMAL CONDUCTIVITY HARD METAL (assigned to Kennametal PC Inc.) discloses such an exemplary carbide material with a lower thermal conductivity (e.g., less than 20 Watt/m° K). In this regard, one preferred composition for the orifice nibs and the wear pads is a tungsten carbide-based cemented carbide substrate. The substrate contains between 50 weight percent and 80 weight percent tungsten carbide, more preferably between about 51 to 62.5 weight percent tungsten carbide, and most preferably, approximately 60 weight percent tungsten carbide. The examples disclose a binder alloy of cobalt and nickel. The substrate further contains titanium carbide (TiC) in amounts of between about 10 and about 40 weight percent. More preferably, the titanium carbide content is between about 20 to 25 weight percent. Most preferably, the titanium carbide content is between about 18 to about 22 weight percent.

According to U.S. Pat. No. 6,521,353 to Majagi et al., limiting grain growth of the tungsten carbide grains is important during processing so that small grain sizes, high hardness, and low porosity may be attained. The substrate may contain a grain growth inhibitor to accomplish this task. Preferably, the grain growth inhibitor can be another metal carbide, alone or in combination, such as molybdenum carbide, chromium carbide, tantalum carbide, niobium carbide or vanadium carbide.

Still another attempt to address the “freezing” problem by providing a hard material with a low thermal conductivity is disclosed a co-pending U.S. patent application Ser. No. 11/751,360 filed May 21, 2007 to Banerjee for CEMENTED CARBIDE WITH ULTRA-LOW THERMAL CONDUCTIVITY, which is assigned to Kennametal Inc. of Latrobe, Pa. 15650. In this regard, one preferred composition for the orifice nibs and the wear pads is a cemented carbide substrate that has significant components of tungsten carbide and titanium carbide. The substrate contains less than about 50 weight percent tungsten carbide. More preferably, the substrate contains between about 51 to 62.5 weight percent tungsten carbide, and most preferably, between about 35 and 40 weight percent tungsten carbide. The titanium carbide content is greater than about 30 weight percent. Preferably, the substrate contains between about 30 weight percent and 45 weight percent titanium carbide, and more preferably, between 35 weight percent and 40 weight percent titanium carbide. In one embodiment, the tungsten carbide content equals the titanium carbide content. The examples disclose a binder alloy of cobalt and nickel.

According to pending U.S. patent application Ser. No. 11/751,360, limiting grain growth of the tungsten carbide grains is important during processing so that small grain sizes, high hardness, and low porosity may be attained. The substrate may contain a grain growth inhibitor to accomplish this task. Preferably, the grain growth inhibitor can be another metal carbide, alone or in combination, such as molybdenum carbide, chromium carbide, tantalum carbide, niobium carbide or vanadium carbide.

As one can appreciate, there is an advantage with a pelletizing die that can operate to maintain the molten material at sufficiently high temperatures to reduce or eliminate “freezing-off” of the passages. Thus, it would be highly desirable to provide an improved pelletizing die that can operate to maintain the molten material at sufficiently high temperatures to reduce or eliminate “freezing-off” of the passages.

Still another challenge to increase overall production has been to lessen or eliminate the erosion-corrosion and the cavitation-corrosion of the pelletizing die plate connected with extrusion process. Such corrosion can occur in the passages due to the movement of the molten material through the passages, i.e., relative to the pelletizing die plate defining the passage. Such corrosion can also occur of the pelletizing die plate face.

As one can appreciate, there is an advantage with a pelletizing die plate that can exhibit a high degree of corrosion resistance, especially when operating in a water environment. Thus, it would be highly desirable to provide an improved pelletizing die plate that can exhibit a high degree of corrosion resistance (i.e., resistance to erosion-corrosion and resistance to cavitation-corrosion), especially when operating in water.

### SUMMARY OF THE INVENTION

In one form, the invention is a pelletizing die plate for use with a main die body having passageways. The pelletizing die plate comprises a die plate body, which comprises a hard composite material comprising a low thermal conductivity matrix of hard matrix particles and an infiltrant alloy bonded to the hard matrix particles to form the hard composite material. The hard matrix particles comprise greater than zero and up to about 20 weight percent titanium carbide particles and the balance cast tungsten carbide particles. The infiltrant alloy contains at least one or more of nickel and copper. The hard matrix particles comprise between about 50 weight percent and about 70 weight percent of the hard composite material and the infiltrant alloy comprises between about 30 weight percent and about 50 weight percent of the hard composite material. The hard composite material has a thermal conductivity less than or equal to about 25 Watt/m° K. The die plate body has bores in alignment with the passageways in the main die body thereby forming continuations of the passageways of the main die body.

In another form thereof, the invention is a pelletizing die plate for use with a main die body having passageways. The pelletizing die plate comprises a die plate body, which comprises a hard composite material comprising a low thermal conductivity matrix of hard matrix particles and an infiltrant alloy bonded to the hard matrix particles to form the hard composite material. The hard matrix particles comprise cemented carbide particles comprising between about 50 weight percent and about 80 weight percent tungsten carbide, between about 10 weight percent and about 40 weight percent titanium carbide and between about 6 weight percent and about 25 weight percent of a binder alloy selected from the group consisting of cobalt, nickel and a combination of cobalt and nickel. The infiltrant alloy contains at least one or more of nickel and copper. The hard matrix particles comprise between about 50 weight percent and about 70 weight percent of the hard composite material and the infiltrant alloy comprising between about 30 weight percent and about 50 weight percent of the hard composite material. The hard composite material has a thermal conductivity less than or equal to about 20 Watt/m° K. The die plate body has bores in alignment with the passageways in the main die body thereby forming continuations of the passageways of the main die body.

In still another form thereof, the invention is a pelletizing die plate for use with a main die body having passageways. The pelletizing die plate comprises a die plate body, which comprises a hard composite material comprising a low thermal conductivity matrix of hard matrix particles and an infiltrant alloy bonded to the hard matrix particles to form the hard composite material. The hard matrix particles comprises cemented carbide particles comprising between about 30 weight percent and less than about 50 weight percent tungsten carbide, between about 30 weight percent and less than about 50 weight percent titanium carbide and between about 10 weight percent and about 30 weight percent of a binder alloy selected from the group consisting of cobalt, nickel and a combination of cobalt and nickel. The infiltrant alloy contains at least one or more of nickel and copper. The hard matrix particles comprise between about 50 weight percent and about 70 weight percent of the hard composite material and the infiltrant alloy comprises between about 30 weight percent and about 50 weight percent of the hard composite material. The hard composite material has a thermal conductivity less than or equal to about 12 Watt/m° K. The die plate body has bores in alignment with the passageways in the main die body thereby forming continuations of the passageways of the main die body.

In yet another form thereof, the invention is a method of making a pelletizing die assembly comprising the steps of: providing a main die body wherein the main die body having a first end face and a second end face, and a plurality of passageways extending through said main die body between said first and second end faces; placing a first mass of hard matrix particles on the second end face of the main die body; placing a second mass of infiltrant alloy on the first mass of hard matrix particles; heating the first mass and the second mass whereby the infiltrant alloy infiltrates the first mass to form a hard composite material comprising a solid mass of the hard matrix particles bonded together by the infiltrant alloy; and forming bores in the hard composite material to form a top die plate wherein the bores are in alignment with the passageways in the main die body.

In still another form thereof, the invention is a pelletizing die plate for use with a main die body having passageways. The pelletizing die plate comprises a die plate body, which comprises a plurality of nibs wherein each one of the nibs has an exterior surface. Each one of the nibs corresponds with one of the passageways in the main die body. The die plate body further comprises a hard composite material that surrounds the nibs so as to bond with the exterior surface of the nibs. The hard composite material comprises a matrix of hard matrix particles and an infiltrant alloy bonded to the hard matrix particles to form the hard composite material. Each one of the nibs has a thermal conductivity less than or equal to about 25 Watt/m° K. Each one of the nibs has a bore in alignment with the corresponding passageways in the main die body thereby forming continuations of the passageways of the main die body.

### BRIEF DESCRIPTION OF THE DRAWINGS

The following is a brief description of the drawings that form a part of this patent application:

FIG. 1 is a front view of a specific embodiment of the pelletizing die;

FIG. 2 is an enlarged front view of a section of the pelletizing die of FIG. 1 that includes section line 5-5;

FIG. 3 is a cross-sectional view showing the first basic step in the manufacture of a first specific embodiment of a pelletizing die plate, which is on the front face of the main die body, and wherein the cross section is along section line 5-5 of FIG. 2;

FIG. 4 is a cross-sectional view showing the second basic step in the manufacture of the first specific embodiment of the pelletizing die plate, and wherein the cross section is along section line 5-5 of FIG. 2;

FIG. 5 is a cross-sectional view of a first specific embodiment of the pelletizing die, which contains a wear pad in the die plate face, taken along section line 5-5 of FIG. 2;

FIG. 6 is a cross-sectional view of a second specific embodiment of the pelletizing die, which does not contain a wear pad in the die plate face, wherein the sectioning is along the lines of that in FIG. 5;

FIG. 7 is a cross-sectional view of a third specific embodiment of the pelletizing die, which contains nibs, which exhibit a low thermal conductivity, defining passageways in the die plate wherein the sectioning is along the lines of that in FIG. 5;

FIG. 8 is a cross-sectional view showing the first basic step in the manufacture of the pelletizing die plate of FIG. 7, which is on the front face of the main die body of the third specific embodiment of the pelletizing die, and wherein the cross section is along the lines of that in FIG. 5;

FIG. 9 photomicrograph (200× with a 100 micrometer scale) of the microstructure of the hard composite material for the top die plate of Specific Example No. 1, and wherein TiC grains are indicated by an arrow; and

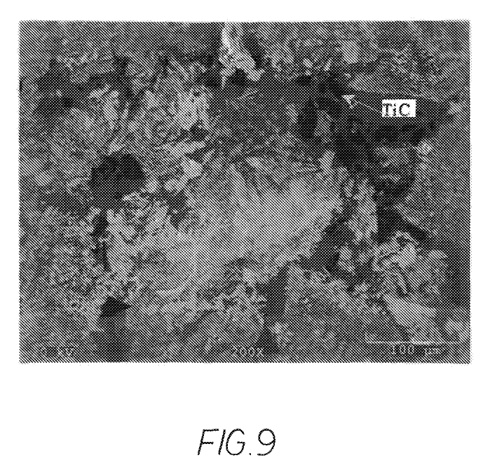

FIG. 10 photomicrograph (1000× with a 20 micrometer scale) of the microstructure of the hard composite material for the top die plate of Specific Example No. 2, and wherein titanium carbide (TiC) grains are indicated by an arrow and the niobium carbide (NbC) grains are indicated by another arrow.

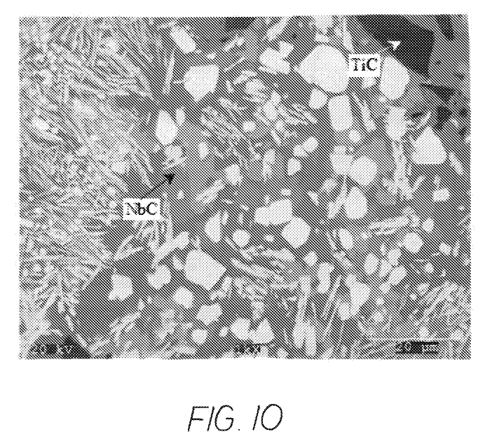

### DETAILED DESCRIPTION

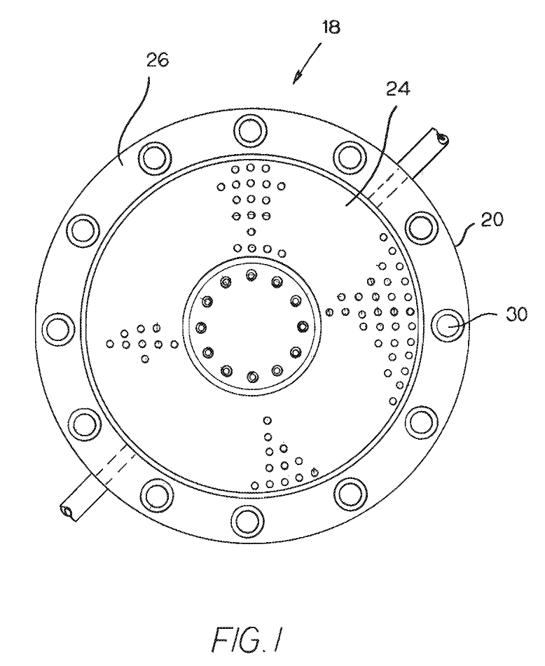

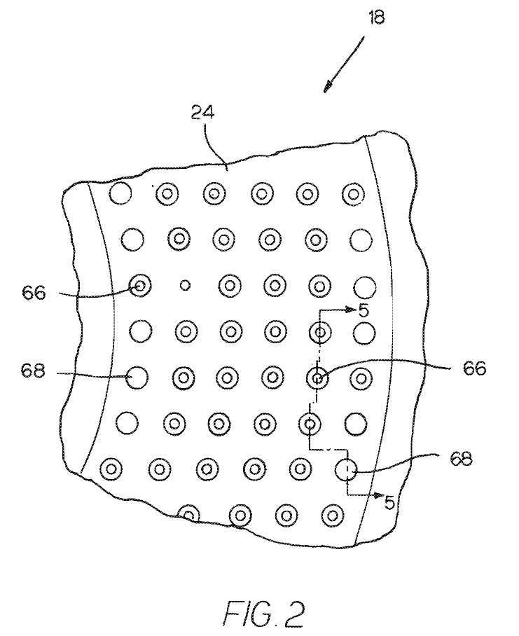

The drawings, and in particular FIGS. 1, 2 and 5, show a first specific embodiment of an extrusion die assembly generally designated as 18 comprising a main die body 20 and a top plate or cover member 24 which is connected to the forward end face of the main die body 20. This pelletizing die assembly has a construction generally along the lines of the pelletizing die assembly shown and described in U.S. Pat. No. 4,752,196 to Wolfe, Jr. The extrusion die assembly is adapted for use with a conventional extruder apparatus, which is well-known to the skilled artisan. In using the subject invention in its preferred environment, a synthetic resin or polymeric plastic material in molten or fluid form is extruded from the extruder through main die body 20 and outwardly through cover or top die plate member 24. The interior of the die body is maintained at an elevated temperature in a manner described hereinafter.

The outer surface of cover member 24 is normally continuously disposed in a cooling bath of water or other liquid maintained at a temperature substantially lower than the temperature of the interior of main die body 20. As the synthetic resin or polymeric plastic material in a liquid or fluid state is extruded through the main die body 20 and the cover member 24. The resin or polymeric material is cooled to a solid state as it discharges into the cooling bath. As the solidified material enters the cooling bath, it is cut into pellets by a knife or knives, which periodically wipe across the outer surface of cover member 24. This general process is well-known in the art and is commonly referred to as underwater pelletizing.

Still referring to FIGS. 1, 2 and 5, main die body 20 is defined by a generally cylindrical body 26 formed from any suitable material, e.g., stainless steel, and provided about its outer periphery with a plurality of counter bored, bolt receiving openings 30 which allow the body 26 to be suitably connected to the associated extruder (not shown). In addition, a plurality of similarly counter bored openings are formed generally axially through body 26 adjacent the center area thereof to also provide for mounting of the assembly.

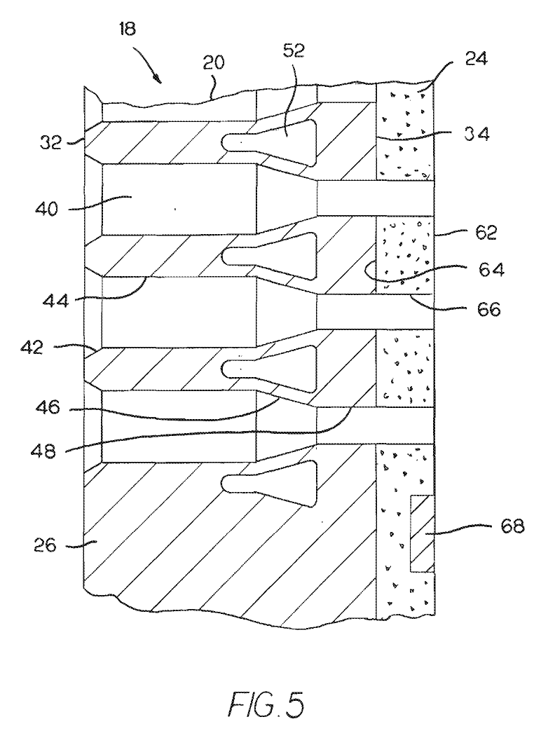

Referring especially to FIG. 5, body 26 includes a pair of oppositely disposed, generally parallel first and second end faces 32 and 34. First end face 32 is arranged to be connected to the discharge end of the extruder to receive the molten or fluid resin or plastic material coming therefrom. A multiplicity of relatively closely spaced, generally parallel extrusion passageways 40 extend in the axial direction through body 26. In the embodiment under consideration, all of the extrusion passageways 40 are generally identical in configuration and include a tapered inlet end opening 42 with an enlarged, generally cylindrical passageway section 44. The inner end of section 44 is provided with a tapered passageway section 46 leading to the outlet section 48 which extends through face 20. There should be an appreciation that the extrusion passageways may present different configurations from that illustrated. There should also be an appreciation that the extrusion passageways may present different configurations within the same body 26.

Heating means is provided to maintain the body 26 at an elevated temperature sufficient to prevent solidification of the molten or fluid material during its travel through passageways 40. In the subject embodiment, the heating means comprises a plurality of fluid passages 52 formed transversely of the body intermediate aligned rows of passageways 40. The passages 52 are sealed from passageways 40 and function to conduct a heated fluid such as steam or oil transversely through the die from an inlet to an outlet. One should understand that the opposite ends of passages are suitably connected to the inlet and outlet by internal header passages (not shown).

Referring to FIG. 5, the top plate 24 can be made from a hard composite material made via an infiltration method as disclosed in U.S. Pat. No. 6,984,454 to Majagi entitled WEAR-RESISTANT MEMBER HAVING A HARD COMPOSITE COMPRISING HARD CONSTITUENTS HELD IN AN INFILTRANT MATRIX, that is assigned to Kennametal Inc., and is hereby incorporated in its entirety by reference herein. Broadly speaking, the infiltration method comprises positioning a layer of hard matrix particles on the surface of an article, positioning a layer of infiltrant alloy powder or particles on the layer of hard matrix particles, and then heating the layers whereby the infiltrant alloy infiltrates the layer of hard particles to form a solid mass, which is the hard composite material. The infiltrant alloy typically has a melting point low enough to not degrade the hard particles upon contact. Set forth hereinafter are suitable compositions of the hard matrix particles and the infiltrant alloys.

The top plate (or die plate) 24 is affixed to the second end face 34 of the main die body 20. The top plate 24 has a forward face 62 and a rearward face 64. The rearward face 64 is the location at which the top plate 24 affixes to the main die body 20. The top plate 24 has a plurality of bores or passages 66, which are in alignment with the passages 40. The top plate 24 also has a wear member 68, which is a discrete hard member. Further, the forward face 62 may contain more than one wear member. In the method to make the top plate that contains the discrete hard member, one selectively positions the discrete hard member in the layer of hard matrix particles. Such positioning of the discrete hard member occurs prior to the application of the layer of infiltrant alloy.

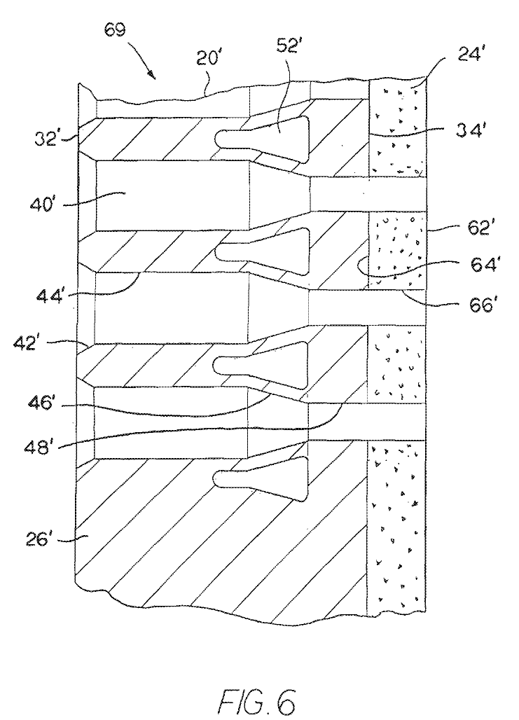

One should appreciate that wear member 68 is optional so that it can be absent from a specific embodiment of the top die plate. In this respect, FIG. 6 illustrates a second specific embodiment of an extrusion die generally designated as 69. Extrusion die 69 has a main die body 20′ that present a structure like main die body 20 of the first specific embodiment of the extrusion die 18. In FIG. 6, structural features common to the first and second specific embodiments of the extrusion die are referenced by the same reference numeral, except that it is primed. The die plate 24′ is along the lines of the die plate 24 in FIG. 5, except that the die plate 24′ in FIG. 6 does not contain a wear pad or the like in the face thereof.

In view of the demands on the top plate, the top plate 24 made from the hard composite material satisfies certain criteria. The top plate 24 should exhibit a low thermal conductivity. For example, the top plate 24 should exhibit a thermal conductivity of less than or equal to about 22 Watts/m° K as measured by the laser flash technique according to ASTM E1461-01, Standard Test Method for Thermal Diffusivity of Solids by the Flash Method. More preferably, the top plate 24 should exhibit a thermal conductivity of less than 20 Watts/m° K as measured by the above laser flash technique. Most preferably, the top plate 24 should exhibit a thermal conductivity of less than or equal to about 12 Watts/m° K as measured by the above laser flash technique.

The top plate 24 should have hardness equal to or greater than about 55 Rockwell C, and more preferably equal to or greater than about 60 Rockwell C. By possessing such a hardness level, the top plate 24 will have a wear resistance to experience a longer useful life. The top plate 24 should exhibit a high corrosion resistance. This corrosion resistance would be with respect to erosion-corrosion and cavitation-corrosion.

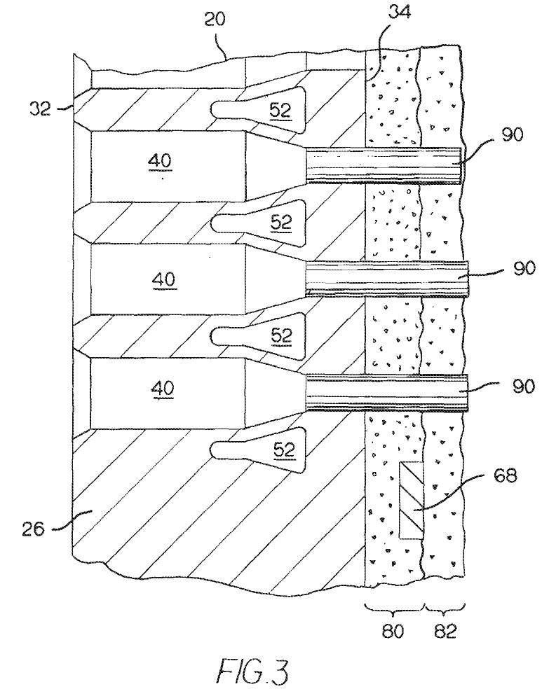

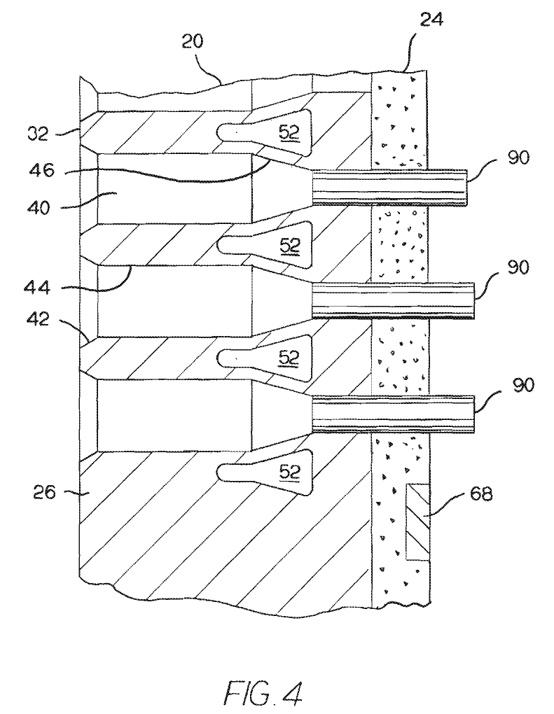

An infiltration process according to U.S. Pat. No. 6,984,454 produces the top plate 24 wherein the top plate 24 affixes to the main die body 20. FIG. 3 and FIG. 4 illustrate the first and second basic steps of the process. FIG. 5 illustrates the finished structure with the top die plate 24 affixed to the die body. FIGS. 3 through 5 herein illustrate a specific embodiment that contains a wear pad in the face of the die plate. As described herein, in the alterative, the die plate, such as the die plate shown in FIG. 5A, may not include a wear pad in the face thereof.

FIG. 3 illustrates the first basic step in the process. Here, the a mass of hard matrix particles (see bracket 80) rests on the front surface of the main die body 20. A mass of infiltrant alloy (see bracket 82) is on the surface of the mass of hard matrix particles 80.

A graphite rod 90 is within each passageway 40 and extends therefrom through the layers of the mass of hard matrix particles 80 and infiltrant alloy 82. The composition of the components (i.e., hard matrix particles and infiltrant alloy) can vary; however, one typically selects the infiltrant alloy to be compatible with the constituents of the mass of hard matrix particles and the composition of the main die body 20.

One preferred infiltrant alloy is a nickel-phosphorous alloy with the composition up to 15 weight percent phosphorous and the balance nickel, and possibly other additives (e.g., up to 25 weight percent chromium). More specifically, the infiltrant alloy may comprise between about 5 weight percent and about 15 weight phosphorous and the balance nickel and have a melting point between about 950 degrees Centigrade and about 1250 degrees Centigrade. As an additional additive, the infiltrant alloy may further include between about 11 weight percent and about 17 weight percent chromium. These nickel-phosphorous infiltrant alloys include the commercially available alloys listed in Table 1 below.

TABLE 1
Commercial Infiltrant Alloys Containing Nickel and Phosphorous

| | | Brazing | |
|---|---|---|---|
| | | Temperature | |
| Braze Alloy | Composition (weight percent) | (° C.) | Specification |
| Nicrobraz 10 | 11.0P; 0.06 max C; | 980 | AWS: BNi-6 |
| | and balance Ni | | |
| Nicrobraz 50 | 10.0P; 0.06 max C; | 1065 | AWS: BNi-7 |
| | 14.0Cr and balance Ni | | |
| Nicrobraz 51 | 10.0P; 25.0Cr and | 1065 | |
| | balance Ni | | |

The NICROBRAZ® braze alloys are available through Wall Colmonoy Corporation, 101 West Girard, Madison Heights, Mich. 48071, which sells braze alloys under the designation NICROBRAZ®. NICROBRAZ® is a trademark registered with the United States Patent and Trademark Office per United States Trademark Registrations Nos. 590,737 and 774,526, and wherein the registrant is Wall Colmonoy Corporation.

Other alloys are suitable for use as the infiltrant alloy in the hard component-matrix composite material. These alloys are listed in the following Tables 2 through 5.

In this regard, the alloys in Table 2 contain up to 25 weight percent chromium, up to 5 weight percent boron, as well as additives of iron and silicon, and the balance nickel, except that other additives may be a part of the composition. More specifically, the infiltrant alloy may comprises between about 5 weight percent and about 17 weight percent chromium, between about 2 weight percent and about 5 weight percent boron, between about 2 weight percent and about 5 weight percent iron, between about 2 weight percent and about 5 weight percent silicon, between about 5 weight percent and about 20 weight percent tungsten, and between about 60 weight percent and about 85 weight percent nickel; and the infiltrant alloy having a melting point between about 1050 degrees Centigrade and about 1150degrees Centigrade.

TABLE 2
Commercial Infiltrant Alloys Containing Nickel and Boron

| | | Brazing | |
|---|---|---|---|
| | Composition | Temperature | |
| Braze Alloy | (weight percent) | (° C.) | Specification |
| Nicrobraz 150 | 15.0Cr; 3.5B; 0.06 | 1175 | — |
| | max C; and balance Ni | | |
| Nicrobraz 160 | 11.0Cr; 2.25B; 0.5C; | 1065 | Honeywell |
| | 3.5Fe; 3.5Si and | | (EMS): 54752 |
| | balance Ni | | |
| Nicrobraz 170 | 12.0Cr; 2.5B; 0.5C; | 1175 | AWS: BNi-10 |
| | 3.5Fe; 3.5Si; 16.0W; | | |
| | and balance Ni | | |
| Nicrobraz 171 | 10.0Cr; 2.5B; 3.5Si; | 1175 | AWS: BNi-11 |
| | 12.0W; 3.5Fe; 0.4C; | | |
| | and balance Ni | | |
| Nicrobraz 200 | 7.0Cr; 3.2B; 4.5Si; | 1120 | According to |
| | 6.0W; 3.0Fe; 0.06 | | Wall Colmonoy, |
| | max C; and balance | | U.S. Pat. No. |
| | Ni | | 2,868,639 covers |
| | | | this braze alloy. |

Other suitable alloys such as those set forth in Table 3 and 4 include an alloy with up to 25 weight percent chromium, up to 15 weight percent silicon and the balance nickel, except that boron may be an additive. More specifically, the infiltrant alloy may comprise between about 14 weight percent and about 20 weight percent chromium, and between about 7 and about 12 weight percent silicon and between about 68 weight percent and about 79 weight percent nickel, and the infiltrant alloy having a melting point between about 1050 degrees Centigrade and about 1200 degrees Centigrade.

TABLE 3
Commercial Infiltrant Alloys Containing Nickel and Silicon

| | | Brazing | |
|---|---|---|---|
| | | Temperature | |
| Braze Alloy | Composition (weight percent) | (° C.) | Specification |
| Nicrobraz 30 | 19.0Cr; 10.2Si; 0.06 max C; | 1190 | AWS: BNi-5 |
| | and balance Ni | | AWS: 4782 |

TABLE 4
Commercial Infiltrant Alloys Containing Nickel (special purpose)

| | | Solidus/ | |
|---|---|---|---|
| | Composition | Liquidus | |
| Braze Alloy | (weight percent) | (° C.) | Specification |
| Nicrobraz 3002 | 15.0Cr; 8.0Si; and | 1975/2075 (F.) | General Electric; |
| | balance Ni | | B50T143 |
| Nicrobraz 3003 | 17.0Cr; 9.0Si; | 1080/1140 | General Electric: |
| | 0.10B and balance | | B50T142 |
| | Ni | | |

Referring to Table 5, a cobalt-based braze alloy may also be suitable for the infiltrant alloy. In this regard, the infiltrant alloy may comprises between about 17 weight percent and about 21 weight percent chromium, and between about 0.6 and about 1.0 boron, and between about 7 and about 9 weight percent silicon, between about 3 weight percent and about 5 weight percent tungsten, and between about 45 weight percent and about 55 weight percent cobalt and between about 14 weight percent and about 20 weight percent nickel, and the infiltrant alloy having a melting point between about 1150 degrees Centigrade and about 1200 degrees Centigrade.

TABLE 5
Commercial Infiltrant Alloy Containing Cobalt

| | | Brazing | |
|---|---|---|---|
| | Composition | Temperature | |
| Braze Alloy | (weight percent) | (° C.) | Specification |
| Nicrobraz 210 | 17.0Ni; 19.0Cr; 0.8B; | 1205 | AWS: BCo-1 |
| | 8.0Si 4.0W; 0.40C | | |
| | and balance Cobalt | | AMS: 4783 |

The preferred hard matrix particles include the compositions set forth in Table 6. In Table 6, the compositions are set forth in weight percent. The particle sizes are set forth in mesh as determined by the ASTM B330-98el Standard Test Method for Average Particles Size Fisher Metal Powders of Refractory Metals and Their Related Compounds by the Fisher Sub-Sieve Sizer.

TABLE 6
Composition in Weight Percent of Suitable Hard Matrix Particles

| | TiC | | | |
|---|---|---|---|---|
| Matrix | (weight | NbC (weight | Macro WC | |
| Composition | percent) | percent) | (weight percent) | Balance |
| No. 1 | up to 20% | none | none | cast carbide |
| No. 2 | up to 20% | up to 10% | none | cast carbide |
| No. 3 | up to 20% | up to 10% | up to 10% | cast carbide |
| Particle | −325 | −325 | −80 + 325 | −80 + 325 |
| Size (Mesh) | | | | |

Cast tungsten carbide particles may be manufactured by melting pure tungsten powder with sufficient carbon to obtain the desired percent tungsten carbide. The tungsten-carbon material is then cast into suitable shapes in chilled molds, preferably by the centrifugal casting process in order to obtain the densest possible product. The resultant castings are then crushed into graded sizes.

Suitable hard matrix particles include cemented carbides as described in U.S. Pat. No. 6,521,353 to Majagi et al. More specifically, these cemented carbides exhibit a low thermal conductivity. These materials comprise any of the following hard drills set forth in Table 7. Table 7 sets forth the starting composition of these examples of cemented carbides suitable as hard matrix particles.

TABLE 7
Compositions (Weight Percent) of Suitable Cemented Carbides
for the Hard Matrix Particles

| | Co | Ni | | TiC | Mo₂C | |
|---|---|---|---|---|---|---|
| Grade Name | (%) | (%) | TaNbC (%)* | (%)** | (%) | WC*** |
| RX2015-b1 | 9.0 | 4.0 | 2.5 | 20 | — | 64.5 |
| RX2015-b2 | 9.0 | 4.0 | 2.5 | 20 | — | 64.5 |
| RX2015-1 | 3 | 10 | 5 | 25 | — | 57 |
| RX2015-2 | 3 | 10 | 5 | 20 | — | 62 |
| RX2015-3 | 3 | 10 | 5 | 15 | — | 67 |
| RX2015-4 | 3 | 10 | 5 | 10 | — | 72 |
| RX2015-5 | 9.0 | 4.0 | 2.5 | 22.5 | 0.5 | 61.5 |
| RX2015-6 | 9.0 | 4.0 | 2.5 | 20 | 0.5 | 64 |
| RX2015-7 | 9.0 | 4.0 | 2.5 | 22.5 | — | 62 |
| RX2015-8 | 9.0 | 4.0 | 2.5 | 20 | — | 64.5 |
| RX2015-9 | 9.0 | 4.0 | 2.5 | 22.5 | 0.5 | 61.5 |
| RX2015-10 | 9.0 | 4.0 | 2.5 | 20 | 0.5 | 64 |
| RX2015-11 | 9.0 | 4.0 | 2.5 | 22.5 | 0.5 | 61.5 |
| RX2015-12 | 9.0 | 4.0 | 2.5 | 20 | 0.5 | 64 |
| RX2015-13 | 13.0 | — | 2.5 | 20 | — | 64.5 |
| Example [Col. | 9.0 | 4.0 | 2.5 | 20 | — | 64.5 |
| 7, lines 28-45 | | | | | | |
| of ′353 Patent] | | | | | | |
| Powder Size | 0.4-6 | 0.4-4 | up to 5 | up to 5 | up to 5 | 0.5-20 |
| [μm] | | | | | | |

In reference to the starting powders as set forth in Table 7, the * refers to the Ta:Nb ratio which is equal to 62:38. The ** refers to the fact that the titanium carbide was added as WTiC powder with the weight ratio of W:Ti equal to 50:50. The *** refers to the fact that this component includes the total of the WC added as WTiC and the WC added as WC powder. The starting powders include a wax content equal to 2 weight percent.

TABLE 8
Compositions (Weight Percent) of Suitable Cemented
Carbides for the Hard Matrix Particles

| Grade | Ni | Co | TaNbC | Cr₃C₂ | TiC | Mo₂C | |
|---|---|---|---|---|---|---|---|
| Name | (%) | (%) | (%)* | (%) | (%)* | (%) | WC*** |
| FERRO 1 | 5 | 1.5 | — | — | 25 | 0.5 | 68 |
| FERRO 2 | 6 | 2 | — | — | 25 | 0.5 | 66.5 |
| FERRO 3 | 5 | 2 | — | — | 25 | — | 68 |
| FERRO 4 | 6 | 2.5 | — | — | 25 | — | 66.5 |
| FERRO 5 | 5 | 2 | — | 0.5 | 25 | — | 67.5 |
| FERRO 6 | 6 | 2.5 | — | 0.5 | 25 | — | 66 |
| FERRO 7 | 5 | 2 | 3 | — | 25 | — | 65 |
| FERRO 8 | 6 | 2.5 | 2.5 | — | 25 | — | 64 |
| FERRO 9 | 5 | 2 | — | — | 23.5 | 0.5 | 68 |
| FERRO 10 | 6 | 2.5 | 2.5 | — | 23.5 | 0.5 | 65 |
| FERRO 11 | 5 | 2 | 2.5 | — | 23 | 0.5 | 68 |
| Powder | 0.4-5 | 0.4-5 | <5 | <5 | <5 | <5 | 0.5-20 |
| Grain Size | | | | | | | |
| (μm) | | | | | | | |

In reference to the starting powders as set forth in Table 8, the * refers to the Ta:Nb ratio which is equal to 62:38. The ** refers to the fact that the titanium carbide was added as WTiC powder with the weight ratio of W:Ti equal to 50:50. The *** refers to the fact that this component includes the total of the WC added as WTiC and the WC added as WC powder. The starting powders include a wax content equal to 2 weight percent.

There is the expectation that each of these compositions in Tables 7 and 8 will perform in a satisfactory fashion. These examples are from U.S. Pat. No. 6,521,353 to Majagi et al.

Suitable hard matrix particles also include cemented carbides as described in co-pending U.S. patent application Ser. No. 11/751,360 filed May 21, 2007. More specifically, certain specific compositions of a cemented carbide with a low thermal conductivity are set forth below in Table 9. These compositions are in weight percent and the particle size is in micrometers.

TABLE 9
Composition (Weight Percent) of Suitable Cemented Carbides
for the Hard Matrix Particles

| Constituent | Weight Percent |
|---|---|
| tungsten carbide | 38.5 |
| titanium carbide | 38.5 |
| chromium carbide | 0.5 |
| nickel | 13.0 |
| cobalt | 7.0 |
| TaNbC | 2.0 |
| molybdenum | 0.5 |

The arrangement as illustrated in FIG. 3 is subjected to heating, and optionally pressure, so that the infiltrant alloy melts. The molten infiltrant alloy infiltrates the mass of hard matrix particles. When the infiltrant alloy solidifies, the result is a hard composite material layer, which is the top die plate 24, metallurgically affixed to the main die body 20 as illustrated in FIG. 4.

The carbide tile 68 (or wear pad) is at the surface of the hard composite material layer. The graphite rods 90 remain in the passageways 40.

As mentioned above, the hard composite material may or may not contain a discrete hard member such as, for example, a wear pad. There is the contemplation that the cemented carbides as set forth in Table 7 through Table 9 are suitable for use as the hard matrix particles. In this situation, the as-sintered cemented carbides would be crushed to an appropriate particle size and particle size distribution and used as a the hard matrix particles.

There is also the contemplation that the cemented carbides as set forth in Table 7 through Table 9 are suitable for use as a discrete hard member. In this case, the discrete as-sintered cemented carbide member would be of the appropriate size and geometry. This discrete as-sintered cemented carbide member would be positioned within the mass of hard matrix particles prior to the infiltration of the infiltrant alloy.

As a final step, the graphite rods 90 are drilled out to form the embodiment as shown in FIG. 5. The finished structure includes a top plate 24 made from the hard composite material.

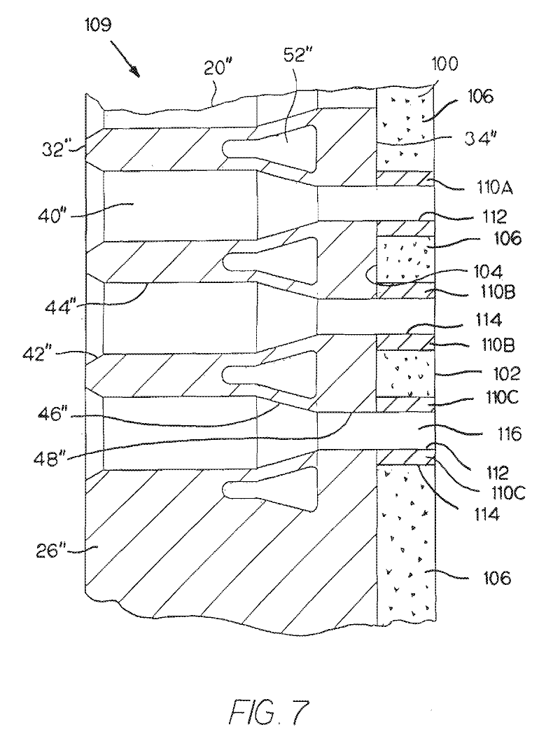

FIG. 7 illustrates a third specific embodiment of the extrusion die generally designated as 109. The extrusion die 109 includes a main die body 20″. The structure of the main die body 20″ is the same as the structure of the main die body 20 of the first specific embodiment 18. The reference numerals for the main die body 20″ are the same as those for the main die body 20, except that they are double primed.

In reference to the die plate 100, the die plate 100 has a forward surface 102 and a rearward surface 104. The top die plate 100 bonds at its rearward surface 104 to the second end face 34″ of the main die body 20″. The die plate 100 contains a hard composite material region 106. The hard composite material region 106 comprises a hard composite material that is the result of infiltrating a mass of hard matrix particles with an infiltrant alloy. The combinations of the hard matrix particles as set forth in Tables 6 through 9 would be expected to be suitable for use with the infiltrant alloys in Tables 1 through 5 to make the hard composite material region 106. The combinations of the hard matrix particles as set forth in Tables 6 through 9 and the infiltrant alloys in Tables 1 through 5 exhibit a low thermal conductivity as described hereinabove.

Further, other combinations of hard matrix particles and infiltrant alloy would be expected to be suitable for use as the hard composite material region 106. More specifically, suitable materials for the hard composite material region include those shown and described in U.S. Pat. No. 6,984,454 to Majagi entitled WEAR-RESISTANT MEMBER HAVING A HARD COMPOSITE COMPRISING HARD CONSTITUENTS HELD IN AN INFILTRANT MATRIX, that is assigned to Kennametal Inc. Exemplary compositions of the hard matrix particles and infiltrant alloys of U.S. Pat. No. 6,984,454 are set forth below.

The hard matrix particles can comprise a crushed cemented carbide particle. The crushed cemented carbide particles may be present in a size range for these crushed cemented carbide particles equal to −325+200 mesh. Another size range for these crushed cemented carbide particles is −80+325 mesh. The standard to determine the particle size is by using sieve size analysis and the Fisher sub-sieve size analyzer for −325 mesh particles. One composition for the crushed cemented carbide particles is cobalt cemented tungsten carbide wherein the cobalt ranges between about 6 weight percent and about 30 weight percent of the cobalt cemented tungsten carbide material and tungsten carbide is the balance of the material. Another preferred composition for crushed cemented carbide particles is cobalt cemented tungsten carbide wherein the cobalt ranges between about 0.2 weight percent and about 6 weight percent of the cobalt cemented tungsten carbide material and tungsten carbide is the balance of the material.

By mentioning specific compositions, there is no intention to limit the scope of the invention to these specific cemented carbides. It is contemplated that other cemented carbides (e.g., chromium carbide) would be suitable for use as the crushed cemented tungsten carbide particles in the hard composite. In this regard, the carbides could be different from tungsten carbide (e.g., titanium carbide and chromium carbide) and the binder could be different from cobalt (e.g., nickel). It is further contemplated that the crushed cemented carbide particles may vary in composition throughout a particular hard composite depending upon the specific application. It is also contemplated that certain hard materials other than cemented carbides may be suitable to form these particles.

The hard matrix particles may also contain crushed cast carbide particles wherein one size range for these particles is −325 mesh. Another size range for these particles is −80 mesh. One composition for these particles is cast tungsten carbide. It is contemplated that the crushed cast carbide particles may vary in composition throughout a particular hard composite depending upon the specific application. It is further contemplated that other cast carbides or hard materials are suitable for use in place or along with the crushed cast carbide particles.

The hard matrix particles may further include in addition to crushed cemented carbide particles and/or crushed cast carbide particles, any one or more of the following: crushed carbide particles (e.g., crushed tungsten carbide particles that have a size of −80+325 mesh), steel particles that have an exemplary size of −325 mesh, carbonyl iron particles that have an exemplary size of −325 mesh, cemented carbide powder, and coated (e.g., nickel coating) cemented carbide particles, and nickel-coated tungsten carbide particles (−80+325 mesh).

In these examples, it is desirable that the infiltrant alloy has a melting point that is low enough so as to not degrade the hard constituents upon contact therewith during the infiltration process. Along this line, generally speaking the infiltrant alloy has a melting point that ranges between about 500 degrees Centigrade and about 1400 degrees Centigrade. It is contemplated that for some instances, the infiltrant alloys may have a melting point that ranges between about 600 degrees Centigrade and about 800 degrees Centigrade. It is further contemplated that in some instances the infiltrant alloys may have a melting point that ranges between about 690 degrees Centigrade and about 770 degrees Centigrade. It is still further contemplated that in some circumstances the infiltrant alloys may have a melting point below about 700 degrees Centigrade. Exemplary general types of infiltrant alloys include copper-based alloys such as, for example, copper-silver alloys, copper-zinc alloys, copper-nickel alloys, copper-tin alloys, and nickel-based alloys including nickel-copper-manganese alloys. In addition to the infiltrant alloys disclosed above, other exemplary infiltrant alloys are set forth in Table 10 herein below.

TABLE 10
Compositions of Infiltrant Alloys in Weight Percent

| | | | | | | | | Solidus (Melting | Liquidus |
|---|---|---|---|---|---|---|---|---|---|
| Alloy/ | | | | | | | | Point) | (Flow |
| Composition | Cu | Ni | Zn | Mn | Ag | Sn | Nb | (° C.) | Point) ° C. |
| A-1 | 53 | 15 | 8 | 24 | — | — | — | 1150 | |
| 202 | 45 | — | 35 | — | 20 | — | — | 710 | 815 |
| 255 | 40 | — | 33 | — | 25 | 2 | — | 690 | 780 |
| 559 | 42 | 2 | — | — | 56 | — | — | 770 | 895 |
| 700 | 20 | — | 10 | — | 70 | — | — | 690 | 740 |
| Cu—20Ni—10Mn | 70 | 20 | — | 10 | — | — | — | ~1100 | |
| Macrofil 56 | 56 | — | 43 | — | — | 1 | — | 866 | 888 |
| Macrofil 65 | 65 | 15 | 20 | — | — | — | — | 1040 | 1075 |
| Macrofil 49 | 49 | 10 | 41 | — | — | — | — | 921 | 935 |
| C96800 | 81.8 | 10 | — | — | — | 8 | 0.2 | 1050 | 1150 |
| Cu—20Ni—20Mn | 60 | 20 | — | 20 | — | — | — | 1030 | 1050 |
| Cu—25Ni—25Mn | 50 | 25 | — | 25 | — | — | — | 1030 | 1050 |

By mentioning specific infiltrant alloys in Table 10, there is no intention to limit the scope of the invention to infiltrant alloys with these specific compositions and/or properties. As one alternative, the composition of the infiltrant alloy could be within the range of 5-40 weight percent nickel, 5-40 weight percent manganese and the balance copper.

Examples of specific hard matrix particles (Mixtures Nos. 1 through 20) are set forth in Tables 11 through 15 hereinafter. In reference to the composition of the matrix powders, it should be appreciated that the crushed tungsten carbide component or the crushed cast tungsten carbide component may be substituted, in whole or in part, by spherical sintered tungsten carbide and/or spherical cast tungsten carbide particles. In some cases the spherical sintered tungsten carbide and/or spherical cast carbide particles (or powders) could be used 100% in combination or alone as the hard constituents in the matrix powders.

TABLE 11
Components of the Hard Matrix Particle Mixtures Nos. 1
through 4 (Weight Percent)

| Constituent | Mixture | | Mixture | | Mixture | | Mixture | |
|---|---|---|---|---|---|---|---|---|
| (particle size) | No. 1 | | No. 2 | | No. 3 | | No. 4 | |
| Crushed tungsten | 67 | wt. % | 67 | wt. % | 0 | wt. % | 0 | wt. % |
| carbide (−80 + | | | | | | | | |
| 325 mesh) | | | | | | | | |
| Crushed tungsten | 0 | wt. % | 15.5 | wt. % | 0 | wt. % | 0 | wt. % |
| carbide (−325 | | | | | | | | |
| mesh) | | | | | | | | |
| Crushed cast | 31 | wt. % | 15.5 | wt. % | 0 | wt. % | 0 | wt. % |
| tungsten carbide | | | | | | | | |
| (−325 mesh) | | | | | | | | |
| 4600 steel (−325 | 1 | wt. % | 0 | wt. % | 0 | wt. % | 0 | wt. % |
| mesh) | | | | | | | | |
| Carbonyl iron | 1 | wt. % | 0 | wt. % | 0 | wt. % | 0 | wt. % |
| (−325 mesh) | | | | | | | | |
| Nickel (−325 | 0 | wt. % | 2 | wt. % | 0 | wt. % | 0 | wt. % |
| mesh) | | | | | | | | |
| Crushed cobalt | 0 | wt. % | 0 | wt. % | 100 | wt. % | | |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Crushed nickel | 0 | wt. % | 0 | wt. % | | | 100 | wt. % |
| (10 wt. Percent) | | | | | | | | |
| cemented | | | | | | | | |
| tungsten carbide | | | | | | | | |
| (−140 + 325 | | | | | | | | |
| mesh) | | | | | | | | |

TABLE 12
Components of the Hard Matrix Particle Mixtures Nos. 5 through 8 (Weight Percent)

| Constituent | | | | | | | | |
|---|---|---|---|---|---|---|---|---|
| (particle size) | Mixture No. 5 | | Mixture No. 6 | | Mixture No. 7 | | Mixture No. 8 | |
| Crushed tungsten | 63.65 | wt. % | 63.65 | wt. % | 0 | wt. % | 0 | wt. % |
| carbide (−80 + 325 | | | | | | | | |
| mesh) | | | | | | | | |
| Crushed tungsten | 0 | wt. % | 14.725 | wt. % | 0 | wt. % | 0 | wt. % |
| carbide (−325 | | | | | | | | |
| mesh) | | | | | | | | |
| Crushed cast | 29.45 | wt. % | 14.725 | wt. % | 0 | wt. % | 0 | wt. % |
| tungsten carbide | | | | | | | | |
| (−325 mesh) | | | | | | | | |
| 4600 steel (−325 | .95 | wt. % | 0 | wt. % | 0 | wt. % | 0 | wt. % |
| mesh) | | | | | | | | |
| Carbonyl iron (−325 | .95 | wt. % | 0 | wt. % | 0 | wt. % | 0 | wt. % |
| mesh) | | | | | | | | |
| Nickel (−325 | 0 | wt. % | 1.9 | wt. % | 0 | wt. % | 0 | wt. % |
| mesh) | | | | | | | | |
| Crushed cobalt | 0 | wt. % | 0 | wt. % | 95 | wt. % | | |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Crushed nickel | 0 | wt. % | 0 | wt. % | | | 95 | wt. % |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Chromium | 5 | wt. % | 5 | wt. % | 5 | wt. % | 5 | wt. % |
| carbide (−45 | | | | | | | | |
| mesh) | | | | | | | | |

TABLE 13
Components of the Hard Matrix Particle Mixtures Nos. 9
through 12 (Weight Percent)

| Constituent | Mixture | | Mixture | | Mixture | | Mixture | |
|---|---|---|---|---|---|---|---|---|
| (particle size) | No. 9 | | No. 10 | | No. 11 | | No. 12 | |
| Crushed tungsten | 53.6 | wt. % | 53.6 | wt. % | 0 | wt. % | 0 | wt. % |
| carbide (−80 + 325 | | | | | | | | |
| mesh) | | | | | | | | |
| Crushed tungsten | 0 | wt. % | 12.4 | wt. % | 0 | wt. % | 0 | wt. % |
| carbide (−325 | | | | | | | | |
| mesh) | | | | | | | | |
| Crushed cast | 24.8 | wt. % | 12.4 | wt. % | 0 | wt. % | 0 | wt. % |
| tungsten carbide | | | | | | | | |
| (−325 mesh) | | | | | | | | |
| 4600 steel (−325 | .8 | wt. % | 0 | wt. % | 0 | wt. % | 0 | wt. % |
| mesh) | | | | | | | | |
| Carbonyl iron (−325 | .8 | wt. % | 0 | wt. % | 0 | wt. % | 0 | wt. % |
| mesh) | | | | | | | | |
| Nickel (−325 | 0 | wt. % | 1.6 | wt. % | 0 | wt. % | 0 | wt. % |
| mesh) | | | | | | | | |
| Crushed cobalt | 0 | wt. % | 0 | wt. % | 80 | wt. % | | |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Crushed nickel | 0 | wt. % | 0 | wt. % | 0 | wt. % | 80 | wt. % |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Nickel Coated | 20 | wt. % | 20 | wt. % | 20 | wt. % | 20 | wt. % |
| Tungsten | | | | | | | | |
| Carbide Powder | | | | | | | | |
| (−325 mesh) | | | | | | | | |

TABLE 14
Components of Hard Matrix Particle Mixtures 13 through 16
(Weight Percent)

| Constituent | Mixture | | Mixture | | Mixture | | Mixture | |
|---|---|---|---|---|---|---|---|---|
| (particle size) | No. 13 | | No. 14 | | No. 15 | | No. 16 | |
| Crushed tungsten | 60.3 | wt. % | 60.3 | wt. % | 0 | wt. % | 0 | wt. % |
| carbide (−80 + 325 | | | | | | | | |
| mesh) | | | | | | | | |
| Crushed tungsten | 0 | wt. % | 13.95 | wt. % | 0 | wt. % | 0 | wt. % |
| carbide (−325 | | | | | | | | |
| mesh) | | | | | | | | |
| Crushed cast | 27.9 | wt. % | 13.95 | wt. % | 0 | wt. % | 0 | wt. % |
| tungsten carbide | | | | | | | | |
| (−325 mesh) | | | | | | | | |
| 4600 steel (−325 | .9 | wt. % | 0 | wt. % | 0 | wt. % | 0 | wt. % |
| mesh) | | | | | | | | |
| Carbonyl iron (−325 | .9 | wt. % | 0 | wt. % | 0 | wt. % | 0 | wt. % |
| mesh) | | | | | | | | |
| Nickel (−325 | 0 | wt. % | 1.8 | wt. % | 0 | wt. % | 0 | wt. % |
| mesh) | | | | | | | | |
| Crushed cobalt | 0 | wt. % | 0 | wt. % | 90 | wt. % | | |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Crushed nickel | 0 | wt. % | 0 | wt. % | 0 | wt. % | 90 | wt. % |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Crushed nickel | 10 | wt. % | 10 | wt. % | 10 | wt. % | 10 | wt. % |
| (15 wt %) | | | | | | | | |
| cemented | | | | | | | | |
| chromium | | | | | | | | |
| carbide(Ni—Cr₃C₂) | | | | | | | | |
| (−140 + 325 | | | | | | | | |
| mesh) | | | | | | | | |

TABLE 15
Components of Hard Matrix Particle Mixtures 17 through 20
(in Weight Percent)

| Constituent | | | | | | | | |
|---|---|---|---|---|---|---|---|---|
| (particle size) | Mixture No. 17 | | Mixture No. 18 | | Mixture No. 19 | | Mixture No. 20 | |
| Crushed tungsten | 56.95 | wt. % | 56.95 | wt. % | 0 | wt. % | 0 | wt. % |
| carbide (−80 + 325 | | | | | | | | |
| mesh) | | | | | | | | |
| Crushed tungsten | 0 | wt. % | 13.175 | wt. % | 0 | wt. % | 0 | wt. % |
| carbide (−325 | | | | | | | | |
| mesh) | | | | | | | | |
| Crushed cast | 26.35 | wt. % | 13.175 | wt. % | 0 | wt. % | 0 | wt. % |
| tungsten carbide | | | | | | | | |
| (−325 mesh) | | | | | | | | |
| 4600 steel (−325 | .85 | wt. % | 0 | wt. % | 0 | wt. % | 0 | wt. % |
| mesh) | | | | | | | | |
| Carbonyl iron (−325 | .85 | wt. % | 0 | wt. % | 0 | wt. % | 0 | wt. % |
| mesh) | | | | | | | | |
| Nickel (−325 | 0 | wt. % | 1.7 | wt. % | 0 | wt. % | 0 | wt. % |
| mesh) | | | | | | | | |
| Crushed cobalt | 0 | wt. % | 0 | wt. % | 85 | wt. % | | |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Crushed nickel | 0 | wt. % | 0 | wt. % | | | 85 | wt. % |
| (10 wt. Percent) | | | | | | | | |
| cemented | | | | | | | | |
| tungsten carbide | | | | | | | | |
| (−140 + 325 | | | | | | | | |
| mesh) | | | | | | | | |
| Nickel-coated | 15 | wt. % | 15 | wt. % | 15 | wt. % | 15 | wt. % |
| tungsten carbide | | | | | | | | |
| (−325 mesh) | | | | | | | | |

The die plate 100 further contains a plurality of cylindrical nibs (110A, 110B and 110C) corresponding with each passageway in the main die body 20″. Each nib 100 has an interior surface 112 that defines a bore 116 of the nib 110, which is in alignment with its corresponding passageway in the main die body 20″. Each nib 110 has an exterior surface 114. Each nib 110 is made of a low thermal conductivity material, such as for example, the material disclosed in U.S. Pat. No. 6,521,353 to Majagi et al. and the co-pending U.S. patent application Ser. No. 11/751,360 to Banerjee filed May 21, 2007.

The hard composite material region 106 may exhibit a low thermal conductivity. In this case, a hard composite material made from the hard matrix particles of Tables 6 through 9 and the infiltrant alloy of Tables 1 through 5 would be suitable. In the alterative, the hard composite material region 106 may not exhibit a thermal conductivity as low as a hard composite material made from the hard matrix particles of Tables 1 through 15 and the infiltrant alloys of Table 10. In the case where the hard composite material region may not exhibit a low thermal conductivity, it would be expected that the low thermal conductivity properties of the nibs would prevent the molten extruded material from solidifying (or “freezing”).

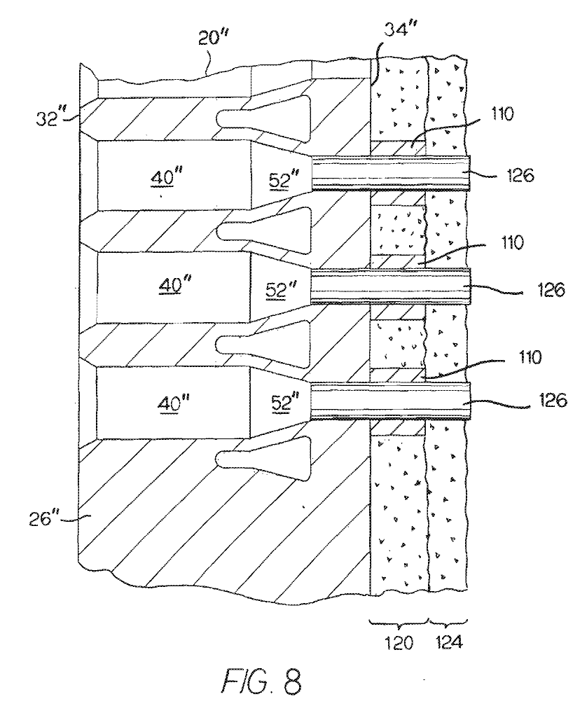

FIG. 8 illustrates the first basic step in the process to make the third specific embodiment of the extrusion die plate of FIG. 7. Here, each one of the nibs 110A-110C is positioned to be in alignment with its corresponding one of the passageways in the main die body 20″. The bore 116 of each nib is in alignment with its corresponding passageway in the main die body. A mass of hard matrix particles (see bracket 120) is positioned on the second end surface 34″ of the main die body 20″. The mass of hard matrix particles 120 also surrounds the exterior surface 114 of each nib 110. A mass of infiltrant alloy (see bracket 124) is on the surface of the mass of hard matrix particles 120. A graphite rod 126 is within each passageway 40 and extends through the bore 116 of each nib. The composition of the components (i.e., hard matrix particles and infiltrant alloy) can vary; however, one typically selects the infiltrant alloy to be compatible with the constituents of the mass of hard matrix particles and the composition of the main die body 20″.

The arrangement as illustrated in FIG. 8 is subjected to heating, and optionally pressure, so that the infiltrant alloy melts. The molten infiltrant alloy infiltrates the mass of hard matrix particles. When the infiltrant alloy solidifies, the result is a hard composite material layer, which is the top die plate 24″, metallurgically affixed to the main die body 20″ as illustrated in FIG. 7. As a final step, the graphite rods 126 are drilled out to form the embodiment as shown in FIG. 7. The Finished structure includes a top plate 24″ made from the hard composite material.

In reference to the production of Specific Example No. 1, the composition of the hard matrix particles comprised about 95 weight percent cast carbide and about 5 weight percent titanium carbide. The infiltrant alloy was NicroBraz 10. A layer of the mixture of the hard matrix particles was positioned on the surface of a support. A layer of infiltrant alloy powder was placed on the surface of the layer of hard matrix particles. In the Specific Example No. 1, the hard matrix particles comprises about 65 weight percent of the hard composite material and the infiltrant alloy comprises about 35 weight percent of the hard composite material. With respect to the range of the composition, the hard matrix particles comprises between about 50 weight percent and about 70 weight percent of the hard composite material. The infiltrant alloy comprises between about 30 weight percent and about 50 weight percent of the hard composite material.

The powder composite was heated to a temperature equal to about 1000° C. whereby the infiltrant alloy infiltrated the mixture of hard matrix particles to form a solid mass, which is the hard composite material. Selected physical properties of the hard composite material of Specific Example No. 1 are set forth below. For Specific Example No. 1, the thermal conductivity equals about 18 Watts/m° K as measured by the laser flash technique of ASTM E1461-01. The hardness of the material of Specific Example No. 1 is about 60 Rockwell C.

FIG. 6 is a photomicrograph (200× with a 100 micrometer scale) of the microstructure of the hard component-matrix composite material for the top plate made according to Specific Example No. 1. In FIG. 6, an arrow points out TiC grains. A description of the production of Specific Example No. 1 is set forth below.

In reference to the production of Specific Example No. 2, the composition of the hard matrix particles comprised about 90 weight percent cast carbide and about 5 weight percent titanium carbide and about 5 weight percent niobium carbide. The infiltrant alloy was NicroBraz 10. A layer of the mixture of the hard matrix particles was positioned on the surface of a support. A layer of infiltrant powder was placed on the surface of the layer of hard matrix particles. In the Specific Example No. 2, the hard matrix particles comprises about 65 weight percent of the hard composite material and the infiltrant alloy comprises about 35 weight percent of the hard composite material. With respect to the range of the composition, the hard matrix particles comprises between about 50 weight percent and about 70 weight percent of the hard composite material. The infiltrant alloy comprises between about 30 weight percent and about 50 weight percent of the hard composite material.

The powder composite was heated to a temperature equal to about 1000° C. whereby the infiltrant alloy infiltrated the mixture of hard matrix particles to form a solid mass. Selected physical properties of the hard component-matrix composite material of Specific Example No. 2 are set forth below. For Specific Example No. 2, the thermal conductivity equals about 20 Watt/m° K as measured by the laser flash technique of ASTM E1461-01. The hardness of the material of Specific Example No. 2 is about 65 Rockwell C.

FIG. 7 is a photomicrograph (200× with a 100 micrometer scale) of the microstructure of the hard component-matrix composite material for the top plate made according to Specific Example No. 2. In FIG. 7, an arrow points out titanium carbide (TiC) grains and another arrow points out the niobium carbide (NbC) grains.

The above description makes it apparent that environmental conditions in which a pelletizing die operates raises a number of challenges to any attempt to increase productivity and quality of the pellets or granules. The above description also makes it apparent that the present invention meets these challenges.

One such challenge has been to increase overall productivity by lessening or eliminating wear on the face of the dies, and especially on the face of the pelletizing die plate. The above invention accomplishes this through using a pelletizing die plate made of a hard composite material. The hardness of the hard composite material is sufficient to achieve satisfactory wear properties.

Another such challenge has been to increase overall production by lessening or eliminating the solidification of material passing through the die. Premature solidification of the material can result in plugging or “freezing-off” of the extrusion passages and/or outlet orifices. The above invention accomplishes this through using a pelletizing die plate made of a hard composite material with a sufficiently low thermal conductivity. The thermal conductivity of the hard composite material is sufficiently low to lessen or eliminate the solidification of the molten material passing through the die.

Still another challenge to increase overall production has been to lessen or eliminate the erosion-corrosion and the cavitation-corrosion of the die plate connected with extrusion process. Such corrosion can occur in the passages due to the movement of the molten material through the passages, i.e., relative to the die plate defining the passage. Such corrosion can also occur of the die plate face. The above invention accomplishes this through using a pelletizing die plate made of a hard composite material with a sufficiently high resistance to erosion-corrosion and cavitation-corrosion.

A still further challenge to increase overall production has been to lessen or eliminate corrosion due to the water operating environment. The above invention accomplishes this through using a pelletizing die plate made of a hard composite material with a sufficiently high resistance to erosion-corrosion and cavitation-corrosion.

A challenge to increase overall production has been to eliminate, especially with die plates that use wear pads, the presence regions that are harder and regions that are softer. It is also a challenge to eliminate the presence of braze joints in the face of the die plate using wear pads. The above invention accomplishes this through using a pelletizing die plate made of a hard composite material that presences a uniform face on the die plate. By doing so, the die plate does not have harder regions and softer regions on its face, and the braze joints are absent from the face of the die plate.

The patents and other documents identified herein are hereby incorporated in their entirety by reference herein. Other embodiments of the invention will be apparent to those skilled in the art from a consideration of the specification or a practice of the invention disclosed herein. There is the intention that the specification and examples are illustrative only and are not intended to be limiting on the scope of the invention. The following claims indicate the true scope and spirit of the invention.

What is claimed:

1. A pelletizing die plate for use with a main die body having passageways, the pelletizing die plate comprising:
a die plate body comprising a hard composite material comprising a low thermal conductivity matrix of hard matrix particles and an infiltrant alloy bonded to the hard matrix particles to form the hard composite material;
the hard matrix particles comprising greater than zero and up to about 20 weight percent titanium carbide particles and the balance cast tungsten carbide particles;
the infiltrant alloy containing at least one or more of nickel and copper;
the hard matrix particles comprising between about 50 weight percent and about 70 weight percent of the hard composite material and the infiltrant alloy comprising between about 30 weight percent and about 50 weight percent of the hard composite material;
the hard composite material having a thermal conductivity less than or equal to about 25 Watt/m° K; and
the die plate body having bores in alignment with the passageways in the main die body thereby forming continuations of the passageways of the main die body.

2. The pelletizing die plate according to claim 1 wherein the hard matrix particles comprise between about 3 weight percent and about 7 weight percent of the titanium carbide particles and between about 93 weight percent and about 97 weight percent of the cast tungsten carbide particles, and the infiltrant alloy comprising a nickel-phosphorous alloy having a melting point between about 950 degrees Centigrade and about 1000 degrees Centigrade, and the nickel-phosphorous alloy comprising between about 8 weight percent and 14 weight percent phosphorous, and the balance nickel.

3. The pelletizing die plate according to claim 1 wherein the hard matrix particles further comprising greater than zero weight percent and up to about 10 weight percent niobium carbide particles.

4. The pelletizing die plate according to claim 3 wherein the hard matrix particles comprise between about 3 weight percent and about 7 weight percent of the titanium carbide particles, between about 3 weight percent and about 7 weight percent of the niobium carbide particles, and between about 86 weight percent and about 94 weight percent of the cast tungsten carbide particles, and the infiltrant alloy comprising a nickel-phosphorous alloy having a melting point between about 950 degrees Centigrade and about 1000 degrees Centigrade, and the nickel-phosphorous alloy comprising between about 8 weight percent and 14 weight percent phosphorous, and the balance nickel.

5. The pelletizing die plate according to claim 3 wherein the hard matrix particles further comprising greater than zero weight percent and up to about 10 weight percent macrocrystalline tungsten carbide particles.

6. The pelletizing die plate according to claim 1 wherein the infiltrant alloy comprising a nickel-phosphorous alloy having a melting point between about 950 degrees Centigrade and about 1000 degrees Centigrade, and the nickel-phosphorous alloy comprising between about 8 weight percent and 14 weight percent phosphorous, and the balance nickel.

7. The pelletizing die plate according to claim 1 wherein the infiltrant alloy comprising a nickel-phosphorous alloy having a melting point between about 1050 degrees Centigrade and about 1100 degrees Centigrade, and the nickel-phosphorous alloy comprising between about 8 weight percent and 12 weight percent phosphorous, between about 10 weight percent and 18 weight percent chromium, and the balance nickel.

8. The pelletizing die plate according to claim 1 wherein the infiltrant alloy comprising a nickel-phosphorous alloy having a melting point between about 1050 degrees Centigrade and about 1100 degrees Centigrade, and the nickel-phosphorous alloy comprising between about 8 weight percent and 12 weight percent phosphorous, between about 22 weight percent and 28 weight percent chromium, and the balance nickel.

9. The pelletizing die plate according to claim 1 wherein the infiltrant alloy comprising a nickel-boron alloy having a melting point between about 1150 degrees Centigrade and about 1200 degrees Centigrade, and the nickel-boron alloy comprising between about 12 weight percent and 18 weight percent chromium, between about 2 weight percent and 5 weight percent boron, and the balance nickel.

10. The pelletizing die plate according to claim 1 wherein the infiltrant alloy comprising a nickel-boron alloy having a melting point between about 1050 degrees Centigrade and about 1100 degrees Centigrade, and the nickel-boron alloy comprising between about 8 weight percent and 14 weight percent chromium, between about I weight percent and 3.5 weight percent boron, between about 0.3 and about 0.7 weight percent carbon, and between about 2 weight percent and about 5 weight percent iron, between about 2 weight percent and about 5 weight percent silicon, and the balance nickel.

11. The pelletizing die plate according to claim 1 wherein the infiltrant alloy comprising a nickel-boron alloy having a melting point between about 1100 degrees Centigrade and about 1200 degrees Centigrade, and the nickel-boron alloy comprising between about 6 weight percent and 13 weight percent chromium, between about 2 weight percent and 4 weight percent boron, between about 2 weight percent and 5 weight percent iron, between about 2 weight percent and 6 weight percent silicon, between about 5 weight percent and 17 weight percent tungsten, and the balance nickel.

12. The pelletizing die plate according to claim 1 wherein the infiltrant alloy comprising a nickel-silicon alloy having a melting point between about 1150 degrees Centigrade and about 1200 degrees Centigrade, and the nickel-silicon alloy comprising between about 13 weight percent and 21 weight percent chromium, between about 6 weight percent and 12 weight percent silicon, and the balance nickel.

13. The pelletizing die plate according to claim 1 wherein the infiltrant alloy comprising a nickel-silicon alloy having a melting point between about 1100 degrees Centigrade and about 1150 degrees Centigrade, and the nickel-silicon alloy comprising between about 15 weight percent and 19 weight percent chromium, between about 7 weight percent and 11 weight percent silicon, between about 0.05 weight percent and about 0.15 weight percent boron, and the balance nickel.

14. The pelletizing die plate according to claim 1 wherein the infiltrant alloy comprising a cobalt-based alloy having a melting point between about 1150 degrees Centigrade and about 1200 degrees Centigrade, and the nickel-boron alloy comprising between about 17 weight percent and 21 weight percent chromium, between about 0.6 weight percent and 1.0 weight percent boron, between about 14 weight percent and 20 weight percent nickel, between about 6 weight percent and 10 weight percent silicon, between about 3 weight percent and 5 weight percent tungsten, and the balance cobalt.

15. A pelletizing die plate for use with a main die body having passageways, the pelletizing die plate comprising:
a die plate body comprising a hard composite material comprising a low thermal conductivity matrix of hard matrix particles and an infiltrant alloy bonded to the hard matrix particles to form the hard composite material;
the hard matrix particles comprising cemented carbide particles comprising between about 50 weight percent and about 80 weight percent tungsten carbide, between about 10 weight percent and about 40 weight percent titanium carbide and between about 6 weight percent and about 25 weight percent of a binder alloy selected from the group consisting of cobalt, nickel and a combination of cobalt and nickel;
the infiltrant alloy containing at least one or more of nickel and copper;
the hard matrix particles comprising between about 50 weight percent and about 70 weight percent of the hard composite material and the infiltrant alloy comprising between about 30 weight percent and about 50 weight percent of the hard composite material;
the hard composite material having a thermal conductivity less than or equal to about 20 Watt/m° K; and
the die plate body having bores in alignment with the passageways in the main die body thereby forming continuations of the passageways of the main die body.

16. The pelletizing die plate according to claim 15 wherein the hard matrix particles further include one or more of tantalum carbide in an amount between about 1 weight percent and about 8 weight percent, niobium carbide in an amount between about 0.5 weight percent and about 5 weight percent, zirconium carbide in an amount between about 0.5 weight percent and about 3 weight percent, molybdenum carbide in an amount between about 0.5 weight percent and about 3 weight percent, and chromium carbide in an amount between about 0.5 weight percent and about 5 weight percent.

17. A pelletizing die plate for use with a main die body having passageways, the pelletizing die plate comprising:
a die plate body comprising a hard composite material comprising a low thermal conductivity matrix of hard matrix particles and an infiltrant alloy bonded to the hard matrix particles to form the hard composite material;
the hard matrix particles comprising cemented carbide particles comprising between about 30 weight percent and less than about 50 weight percent tungsten carbide, between about 30 weight percent and less than about 50 weight percent titanium carbide and between about 10 weight percent and about 30 weight percent of a binder alloy selected from the group consisting of cobalt, nickel and a combination of cobalt and nickel;
the infiltrant alloy containing at least one or more of nickel and copper;
the hard matrix particles comprising between about 50 weight percent and about 70 weight percent of the hard composite material and the infiltrant alloy comprising between about 30 weight percent and about 50 weight percent of the hard composite material;
the hard composite material having a thermal conductivity less than or equal to about 12 Watt/m° K; and
the die plate body having bores in alignment with the passageways in the main die body thereby forming continuations of the passageways of the main die body.

18. The pelletizing die plate according to claim 17 wherein the hard matrix particles further include one or more of tantalum carbide in an amount between about 1 weight percent and about 8 weight percent, niobium carbide in an amount between about 0.5 weight percent and about 5 weight percent, zirconium carbide in an amount between about 0.5 weight percent and about 3 weight percent, molybdenum carbide in an amount between about 0.5 weight percent and about 3 weight percent, and chromium carbide in an amount between about 0.1 weight percent and about 5 weight percent.

19. A pelletizing die plate for use with a main die body having passageways, the pelletizing die plate comprising:
a die plate body comprising a plurality of nibs wherein each one of the nibs having an exterior surface, and each one of the nibs corresponding with one of the passageways in the main die body;
the die plate body further comprising a hard composite material surrounding the nibs so as to bond with the exterior surface of the nibs;
the hard composite material comprising a matrix of hard matrix particles and an infiltrant alloy bonded to the hard matrix particles to form the hard composite material;
each one of the nibs having a thermal conductivity less than or equal to about 25 Watt/m° K; and
each one of the nibs having a bore in alignment with the corresponding passageways in the main die body thereby forming continuations of the passageways of the main die body.

20. The pelletizing die plate according to claim 19 wherein the hard matrix particles comprising greater than zero and up to about 20 weight percent titanium carbide particles and the balance cast tungsten carbide particles; the infiltrant alloy containing at least one or more of nickel and copper; the hard matrix particles comprising between about 50 weight percent and about 70 weight percent of the hard composite material and the infiltrant alloy comprising between about 30 weight percent and about 50 weight percent of the hard composite material; and the hard composite material having a thermal conductivity less than or equal to about 25 Watt/m° K.

21. The pelletizing die plate according to claim 19 wherein the hard matrix particles comprising cemented carbide particles comprising between about 50 weight percent and about 80 weight percent tungsten carbide, between about 10 weight percent and about 40 weight percent titanium carbide and between about 6 weight percent and about 25 weight percent of a binder alloy selected from the group consisting of cobalt, nickel and a combination of cobalt and nickel; the infiltrant alloy containing at least one or more of nickel and copper; the hard matrix particles comprising between about 50 weight percent and about 70 weight percent of the hard composite material and the infiltrant alloy comprising between about 30 weight percent and about 50 weight percent of the hard composite material; and the hard composite material having a thermal conductivity less than or equal to about 20 Watt/m° K.

22. The pelletizing die plate according to claim 19 wherein the hard matrix particles comprising any one or more of the following: cast carbides, spherical sintered carbides, crushed cemented carbide particles, crushed cast carbide particles, crushed carbide particles, and cemented carbide powder, steel particles, carbonyl iron particles, and coated carbide particles; and the infiltrant alloy having a melting point between about 500 degrees Centigrade and about 1400 degrees Centigrade, and the infiltrant alloy containing at least one or more of nickel and copper.

23. A method of making a pelletizing die assembly comprising the steps of:
providing a main die body wherein the main die body having a first end face and a second end face, and a plurality of passageways extending through said main die body between said first and second end faces;
placing a first mass of hard matrix particles on the second end face of the main die body;
placing a second mass of infiltrant alloy on the first mass of hard matrix particles;
heating the first mass and the second mass whereby the infiltrant alloy infiltrates the first mass to form a hard composite material comprising a solid mass of the hard matrix particles bonded together by the infiltrant alloy; and
forming bores in the hard composite material to form a top die plate wherein the bores are in alignment with the passageways in the main die body.

24. The method according to claim 23 further including the step of positioning a discrete hard member in the first mass prior to the step of placing of the second mass on the first mass.

25. The method according to claim 23 further including the step of positioning a nib to correspond with each one of the passageways prior to the step of placing the first mass of hard matrix particles.
